(19) United States
(12) Patent Application Publication
(10) Pub. No.: US 2006/0158668 A1
(43) Pub. Date: Jul. 20, 2006

(54) Method and apparatus for increasing color gamut of a three color primary additive display device

(75) Inventor: Thomas O. Maier, Rochester, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/038,850

(22) Filed: Jan. 20, 2005

(51) Int. Cl. H04N 1/60

(52) U.S. Cl. 358/1.9

(57) ABSTRACT

A method is provided for increasing color gamut of a three color primary additive display device, including the steps of providing an optical wavelength selector in the three color primary additive display device; and decreasing size of a projected image on a viewing screen while maintaining luminance levels having a white value of 48 candelas per square-meter (cd/m²)

### FIELD OF THE INVENTION

This invention generally relates to display systems that form a two-dimensional image and more particularly relates to a color display apparatus and method for generating images having a broadened color gamut.

### BACKGROUND OF THE INVENTION

When computer monitors or digital projectors are used in a post-house to pre-visualize the color that will appear on a film print in the Digital Intermediate process, the color gamut of the computer monitor or the digital projector is significantly smaller than the color gamut of the print film. This means the decisions made about images made on the monitor or digital projector do not use the full color gamut of the print film and thus do not reach the maximum saturation that would be possible on the film print. This results in a lower color quality of the film print that came from the digital intermediate process relative to a film print that came from an all-film process.

A monitor is built to the standards that specify the characteristics of a monitor. Because these standards include specifying the chromaticity coordinates of the phosphors in the monitor, there is little that can be done to increase the color gamut of a monitor. However, a digital projector today commonly uses a beamsplitter with or without additional filters with a Xenon light source to produce its primaries. The primaries are defined by the wavelengths of the original Xenon light that are emitted when a full-on red, green, or blue are called for. The problem is that as the wavelengths in the primaries are reduced or narrowed so as to make purer colors by altering the beamsplitter or the filters, the luminance of the light that is passed decreases and the resulting image becomes dark. An alternative approach to using a beamsplitter with or without filters and Xenon light is the use of lasers as the primaries. However, there are two serious problems with the use of lasers: it has been impractical to produce images of sufficiently high luminance with lasers and the laser light is so intense that, if the beam of laser light were to pass over an observer's eyes, severe damage would be done to the observer's eyes. Therefore, the use of lasers has not proven to be practical.

The use of the Digital Intermediate process to produce movies or sections of movies is becoming much more common. This process combines the ability of film to capture an accurate representation of the original scene in an artistic manner with the freedom to use digital image processing techniques to manipulate the image to produce quickly and easily images that would be very difficult or impossible to produce by either technique alone. As the cost of using the Digital Intermediate process decreases, more and more movies are being made using this process. In most instances only a portion of the movie is made using this process, but, in other cases, the entire movie uses this process.

The problem is that when the images are being manipulated in the Digital Intermediate process, someone is viewing the images. Because these are digital images, they are viewed either on a computer monitor or by use of a digital projector projecting an image on a screen. As can be seen in FIG. 1, the color gamuts of the computer monitor and the digital projector are significantly smaller than the color gamut of motion picture print film. Because many of the more saturated film colors cannot be seen on a monitor or a digital projector and the creative person can only make decisions on colors he or she can see, the creative person cannot make use of the full range of colors available on the film. The net result is a loss in the color quality of the film prints that come from the Digital Intermediate process imagery.

In FIG. 1, the outermost horseshoe shaped area enclosed by the dark line shows the gamut of colors that can be seen as plotted on a chromaticity diagram. The area enclosed by the lighter solid line is the gamut of colors that can be produced on motion picture print film. The triangular area enclosed with the dashed line is the gamut of colors that can be produced using a digital projector. Both the Texas Instruments DLP Cinema Grade Digital Projector and the SMPTE Proposed Standard for a Reference Digital Projector have this gamut. The innermost triangular area enclosed by the dash-dot line is the gamut of colors that can be produced using a computer monitor. This gamut is the gamut of colors as defined by the Rec. ITU-R BT.709-5 Standard. It can be seen that the gamut of colors that can be produced on motion picture print film is considerably larger than the gamut of colors that can be produced on either a digital projector or a computer monitor.

Because print film is a subtractive imaging system, the color gamut on a chromaticity diagram cannot be described by three primaries. However, the digital projector and computer monitor are additive imaging systems and can be described by three primaries. The chromaticity coordinates of the three primaries of the Reference Digital Projector defined by the draft SMPTE standard and of the computer monitor defined by Rec. ITU-R BT.709-5 are shown in Table 1.

TABLE 1
Chromaticity Coordinates, x and y, of the three primaries of the SMPTE
Reference Projector and a computer monitor as defined by
Rec. ITU-R BT.709-5.

| Device | Primary | x | y |
|---|---|---|---|
| Digital Projector | Red | 0.680 | 0.320 |
| Digital Projector | Green | 0.265 | 0.690 |
| Digital Projector | Blue | 0.150 | 0.060 |
| Computer | Red | 0.640 | 0.330 |
| Monitor | | | |
| Computer | Green | 0.300 | 0.600 |
| Monitor | | | |
| Computer | Blue | 0.150 | 0.060 |
| Monitor | | | |

Therefore, there is a need for a method of previewing the images that are being created using the Digital Intermediate process that better show the colors that can be produced on the motion picture print film. In fact, there have been ideas put forth to use lasers as the primaries in the digital projector in order to produce the larger color gamut that is needed to better match the color gamut of print film. However, the use of laser primaries has not found commercial success because the lasers do not have enough power to be used in a digital projector to produce the required luminance on the screen and the laser beam which is sweeping across the screen is sufficiently intense that if an observer were to look at that beam, the observer's eyes would be severely damaged. It would be very beneficial if the color gamut of print film could be shown using existing equipment with minimal and inexpensive modifications to the existing equipment.

### SUMMARY OF THE INVENTION

The present invention is directed to overcoming one or more of the problems set forth above. Briefly summarized, according to one aspect of the present invention, a method is provided for increasing color gamut of a three color primary additive display device, including the steps of providing an optical wavelength selector in the three color primary additive display device, and decreasing size of a projected image on a viewing screen while maintaining luminance levels having a white value of 48 candelas per square-meter (cd/m²).

Another aspect of the present invention provides a three color additive display device for matching a projected image's color gamut with print film color gamut that includes an incoherent light source and a beamsplitter for restricting wavelengths from the incoherent light source to increase color gamut while maintaining luminance levels having a white value of 48 candelas per square-meter (cd/m²).

### ADVANTAGEOUS EFFECT OF THE INVENTION

Digital projectors are built with a Xenon light source and beamsplitters and/or filters that produce red, green, and blue light. The purest red, green, and blue light that can be produced by a device are the primaries of that device. Any particular color is produced by the combination of the appropriate amounts of these red, green, and blue lights.

The color gamut of a three color additive primary device on a chromaticity diagram is a triangular shaped figure with the vertices of the triangle located at the chromaticity coordinates of each of the three additive red, green, and blue primaries. Because both computer monitors and digital projectors are three color additive primary devices, their color gamuts in FIG. 1 are triangles. Beamsplit and/or filtered Xenon light creates the spectral outputs of the primaries in a digital projector. The beamsplitter and filters are chosen so as to be both efficient in the use of the Xenon light and successful in producing a relatively large color gamut. In a large theater the efficient use of the light is very important because of the amount of energy needed to light up a theatrical screen which might be as much as 60 feet wide. However, in a screening room or a color-grading suite where Digital Intermediate images are evaluated, the image size is much smaller, on the order of 6 to 15 feet wide, and the requirement of efficiency is considerably less. As long as the efficiency is not too low, the loss in efficiency can be made up by moving the digital projector closer to the screen or by using a longer focal length lens (a telephoto lens). Because of the small screen size and the small size of a color-grading suite, the digital projector will be closer to the screen than in a motion picture theater. In addition, many motion picture theater screens are smaller than the largest screens because they are in smaller theaters which have fewer seats for the observers.

### BRIEF DESCRIPTION OF THE DRAWINGS

FIG. 1 is a CIE xy Chromaticity Diagram showing the gamuts of human vision, motion picture print film, a typical digital projector, and a typical computer monitor.

FIG. 2 is a CIE xy Chromaticity Diagram showing the gamuts of human vision, motion picture print film, a typical digital projector, a typical computer monitor, and the location of three primaries that would produce a color gamut very close to the film color gamut.

FIG. 3 is a CIE xy Chromaticity Diagram showing the gamuts of human vision, motion picture print film, a typical digital projector, a typical computer monitor, and the location of three other primaries that would produce a color gamut larger than the color gamut of existing digital projectors.

FIG. 4 is a CIE xy Chromaticity Coordinate Diagram showing the triangle outside of which the primaries of this invention must fall.

### DETAILED DESCRIPTION OF THE INVENTION

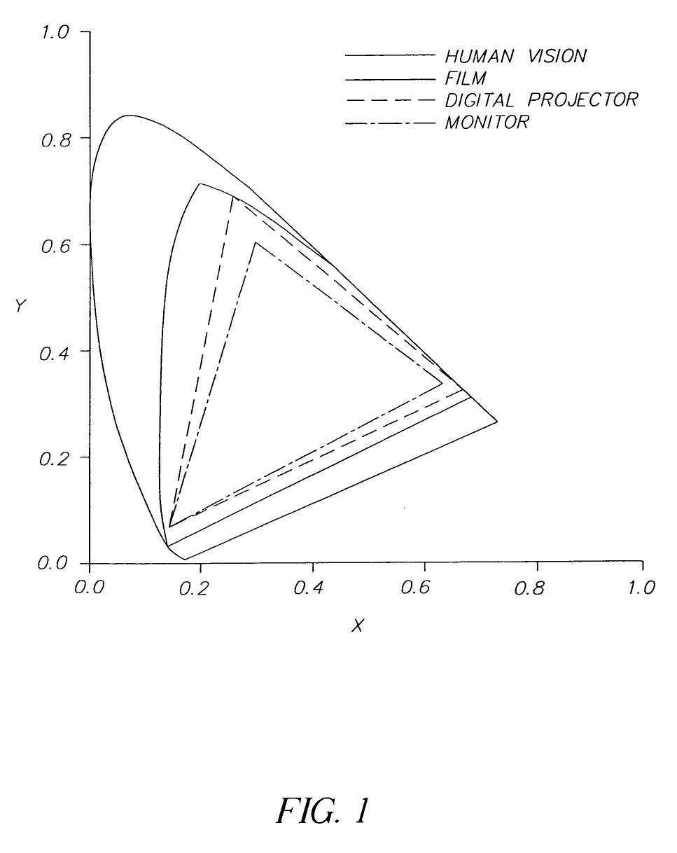

FIG. 1 showed the problem faced today—that a monitor or a digital projector has a color gamut considerably smaller than the color gamut of projected motion picture film.

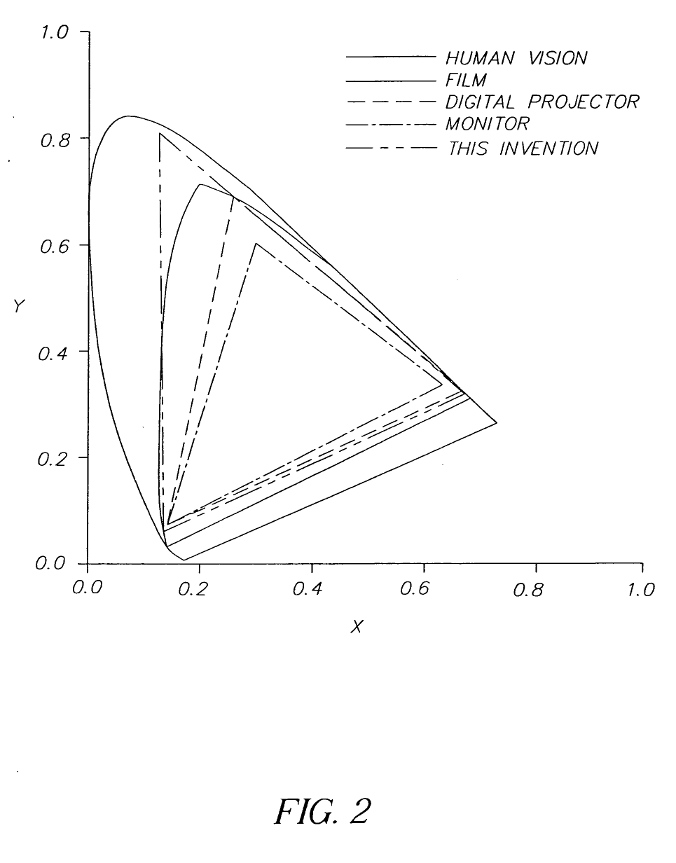

FIG. 2 shows one aspect of the invention that gives a digital projector a color gamut much closer to the color gamut of motion picture print film. In FIG. 2, the dark dotted line represents the color gamut of a three color additive primary device with primaries with the chromaticity coordinates shown in Table 2.

TABLE 2
Chromaticity Coordinates, x and y, of three primaries of this invention.

| Primary | x | y |
|---|---|---|
| Red | 0.6851 | 0.3148 |
| Green | 0.1323 | 0.8063 |
| Blue | 0.1412 | 0.0456 |

These primaries can be made from incoherent light such as Xenon light and an optical wavelength selector (i.e., selecting a narrower range of wavelengths to provide a larger color gamut), for example, three dichroic filters that cut sharply at the wavelengths shown in Table 3, or a beamsplitter either alone or in combination with the set of large gamut filters. In this table, the beamsplitter and/or dichroic filters pass all wavelengths at or greater than the minimum wavelength up to the maximum wavelength and do not pass any light at other wavelengths. The efficiency number is the percent of the luminance of the Xenon lamp that is passed by each filter. The filters in Table 3 pass a total of 41 percent of the luminance put out by the Xenon lamp. Because this efficiency is roughly half of the efficiency of the beamsplitter and/or filters used in a cinema grade digital projector today, the same projector moved closer to a viewing screen so that the viewing screen area is half of the theatrical screen area will have the proper screen luminance. Another embodiment would use a telephoto lens in combination with the digital projector for decreasing the size of the projected image on the viewing screen. Because typical large theatrical screens are at least 50 feet wide, the use of a set of these large gamut filters in a digital projector would be capable of giving the proper illumination to a screen at least 35 feet wide. Because many theatrical screens are no more than 35 feet wide, the use of these primaries would produce at the proper luminance a more saturated digitally projected image than can be shown today. Since a 35 foot wide screen is much wider than a color-grading suite screen, the Xenon lamp needed in a color-grading suite with these primaries has wattage much smaller than the wattage of the Xenon lamp needed in the theater. This means that the use of these filters in a color-grading suite is very practical. One exemplary acceptable luminance level would have a white value of 48 candelas per square-meter (cd/m²).

TABLE 3
Dichroic filters that give with Xenon light the chromaticity coordinates
in Table 2.

| | | Maximum | |
|---|---|---|---|
| Primary | Minimum Wavelength | Wavelength | Efficiency |
| Red | 600 nm | 780 nm | 17 |
| Green | 514 nm | 538 nm | 19 |
| Blue | 400 nm | 490 nm | 5 |

Although the invention described in FIG. 2 and Tables 2 and 3 solve the problem described, the set of filters and the chromaticity coordinates described are not the only solution to the problem. In general, in order to preview images from a Digital Intermediate process, there are many sets of primaries that can be used in a digital projector that will be a better device than a digital projector with the primaries shown in Table 1.

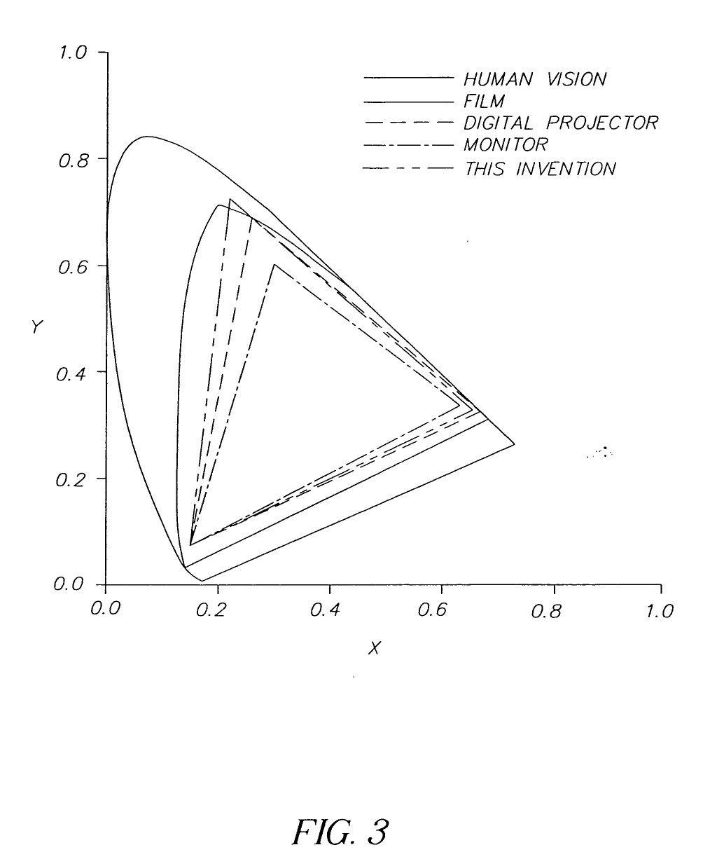

Another embodiment of this invention is shown in Table 4 and FIG. 3. In this embodiment the color gamut of the digital display device is not as large as the color gamut of the motion picture print film, but it is still larger than existing devices and does allow the display of more saturated colors than existing devices. The area of the triangle formed by the primaries in Table 4 is 0.1597 square units in CIE xy Chromaticity Coordinate units.

TABLE 4
CIE xy Chromaticity Coordinates of three primaries of this invention.

| Primary | x | y |
|---|---|---|
| Red | 0.6700 | 0.3200 |
| Green | 0.2200 | 0.7200 |
| Blue | 0.1531 | 0.0695 |

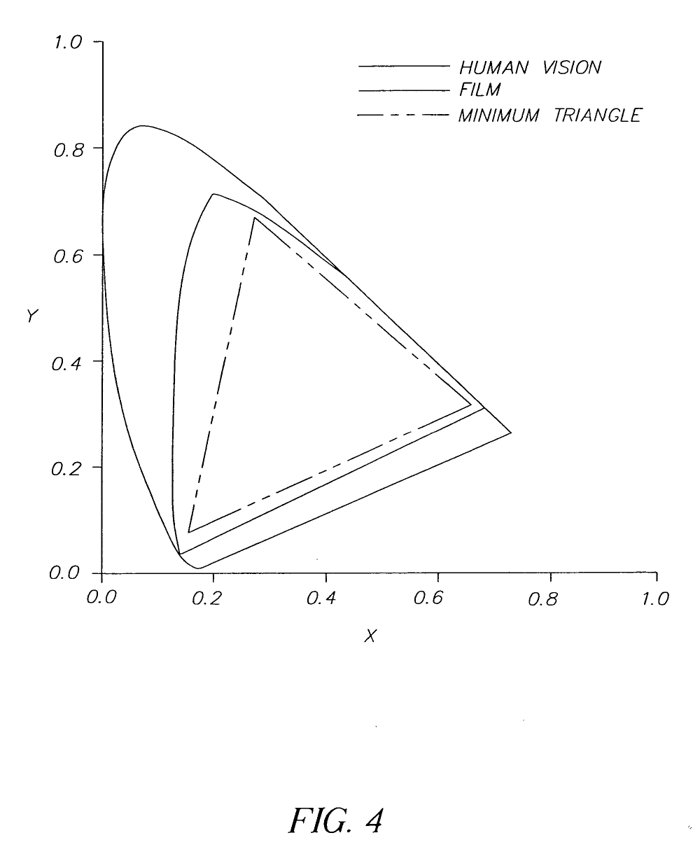

From Tables 2 and 4 it can be seen that there are a large number of color gamuts that will be better than existing display devices. The controlling factor is the location of the primaries of the display device as plotted on a CIE xy Chromaticity Diagram. In general it can be stated that there will be a significant improvement in the saturation of the displayed colors and the match of the displayed colors using a digital display device if the primaries fall outside the triangle formed by the points defined in Table 5 and shown in FIG. 4. In addition, the triangle formed by the primaries of this invention must have an area of at least 0.1596 square units in the CIE xy Chromaticity Coordinate units.

TABLE 5
CIE xy Chromaticity Coordinates that define a triangle outside of which
the primaries of this invention must fall.

| Primary | x | y |
|---|---|---|
| Red | 0.660 | 0.322 |
| Green | 0.268 | 0.670 |
| Blue | 0.160 | 0.077 |

In conclusion, according to one exemplary aspect of the present invention, a display device comprises an incoherent light source for forming a beam of light. An optical wavelength selector selects three bands of light that define the color gamut of the display device. Splitting means splits the beam of light into three color beams of light. Alternatively, a set of filters separates the beam of light into three color beams of light. The use of narrow wavelength beams of light increases the color gamut of the light projected onto a screen. The loss in luminance that results from the use of the narrow wavelength beams of light is compensated for by decreasing the size of the projected image either by moving the projector closer to the screen or by using a longer focal length lens.

The invention has been described with reference to a preferred embodiment. However, it will be appreciated that variations and modifications can be effected by a person of ordinary skill in the art without departing from the scope of the invention.

What is claimed is:

1. A method for increasing color gamut of a three color primary additive display device, comprising the steps of:
a) providing an optical wavelength selector in the three color primary additive display device; and
b) decreasing size of a projected image on a viewing screen while maintaining luminance levels having a white value of 48 candelas per square-meter (cd/m²).

2. The method claimed in claim 1, wherein the step of decreasing the size of the projected image includes varying distance between the three color additive display device and the viewing screen so that luminance levels have a white value of 48 cd/m².

3. The method claimed in claim 1, wherein the step of decreasing the size of the projected image includes using a telephoto lens in combination with the three color additive display device to decrease the size of the projected image on the viewing screen.

4. The method claimed in claim 1, wherein the optical wavelength selector are selected from a beamsplitter, a set of large gamut filters, or a combination of both the beamsplitter and the set of large gamut filters.

5. The method claimed in claim 2, wherein the set of large gamut filters is a set of dichroic filters.

6. A method for previewing digital intermediate images when using a three color additive display device, comprising the steps of:
a) adjusting color primaries of the three color additive display device within predetermined criteria that relates the three color additive display device's color primaries to a multiple of a triangular area formed by three color primaries.

7. A three color additive display device for matching a projected image's color gamut with print film color gamut, comprising:
a) an incoherent light source; and
b) a beamsplitter for restricting wavelengths from the incoherent light source to increase color gamut while maintaining luminance levels having a white value of 48 candelas per square-meter (cd/m²).

8. The three color additive display device claimed in claim 7, further comprising:
a) a telephoto lens to decrease the size of a projected image on a viewing screen.

9. The three color additive display device claimed in claim 7, further comprising:
a) a set of large gamut filters, in combination with the beamsplitter, for providing greater restriction of the wavelengths from the incoherent light source.

10. A method for increasing color gamut for three color primaries, including the steps of:
a) providing the three color primaries outside a triangle formed in CIE xy chromaticity coordinate space by the points [0.660, 0.322], [0.268, 0.670], and [0.160, 0.077]; and
b) enlarging an area of the triangle formed in CIE xy chromaticity coordinate space at least 0.1596 square units in chromaticity coordinate units.
